(19) United States
(12) Patent Application Publication
(10) Pub. No.: US 2008/0203595 A1
(43) Pub. Date: Aug. 28, 2008

(54) SOLUTION CASTING METHOD

(76) Inventors: Kazumasa YOKOYAMA, Kanagawa (JP); Ryou Takeda, Kanagawa (JP)

Correspondence Address: BIRCH STEWART KOLASCH & BIRCH, PO BOX 747, FALLS CHURCH, VA, 22040-0747, US

(21) Appl. No.: 12/035,098

(22) Filed: Feb. 21, 2008

(30) Foreign Application Priority Data
Feb. 23, 2007 (JP) 2007-043991
Sep. 27, 2007 (JP) 2007-252007

(51) Int. Cl. B29C 39/02; B29C 35/16

(52) U.S. Cl. 264/28; 264/39

(57) ABSTRACT

A dope is cast onto a drum whose surface is cooled, so as to form a casting film. After the peeling of the casting film, a cleaning gas containing dry ice particles is applied to a periphery of the casting drum with use of a drum cleaning unit. Thus the dry ice particles collide to the periphery of the casting drum, and the colliding energy is effective of removing from the periphery an organic material adhered on the casting drum. The organic material mainly contains aliphatic acid, aliphatic acid ester and metal salt of aliphatic acid. Before the increase of the amount of the organic material, it is removed and therefore isn't transmitted onto the surface of the casting film. Thus a high quality film having no optical unevenness is produced without the decrease of the productivity.

### BACKGROUND OF THE INVENTION

1. Field of the Invention

The present invention relates to a solution casting method which is adequate for producing an optical film such as a protective film for a polarizing filter in a liquid crystal display, an optical compensation film, a wide view film, and the like.

2. Description Related to the Prior Art

Conventionally a polymer film (herein after a film) has been used as a photosensitive film and the like, since being excellent in optical transparency and flexibility, and lightweight, and further having a possibility to be thinner and smaller. Recently, a cellulose acylate film produced from a cellulose acylate is used as several types of an optical films, such as a protective film for protecting a surface of a polarizing filter in a liquid crystal display, an optical compensation film, a wide view film, and the like, since the cellulose acylate film has not only the merits of the polymer film but is also excellent strength and low birefrigency. Thus the demands for the cellulose acylate film are extremely increasing.

The optical film is usually produced by the solution casting method. In the solution casting method, a dope containing a polymer (cellulose acylate and the like), a solvent and an additive is cast on to a running support to form a casting film, and thereafter the casting film is peeled from the support, and dried to be the film. The solution casting film has merits in that the film production is made without thermal damage, and that the produced film is excellent in the optical transparency, the optical isotropy and the thickness uniformity and contains little foreign materials, and the like.

By the way, while the film is continuously produced by the solution casting method, the surface of the support (hereinafter support surface) sometimes has a pollution. It is considered that the organic materials in the casting film (such as the aliphatic acid, the aliphatic acid ester, the metallic salt of the aliphatic acid and the like) leave from the casting film to remain as the main material of the pollution on the support. The amount of these organic materials becomes larger on time, and thus the support surface loses the smoothness. The increased organic materials often disturb the smoothly peeling, which causes the nonuniformity of peelability or part of the casting film remains on the support. Sometimes, in the most terrible case, the peeling becomes impossible and the film production must be stopped. Thus if the organic materials adheres onto the support, the productivity becomes lower and other problems occur. Therefore in the concrete performance of the film production, the support surface is usually cleansed with use of a nonwoven cloth on regular basis. However, also in this case, the film production speed must be made lower and otherwise the film production must be stopped, which causes the low productivity.

The Japanese Patent Laid Open Publication No. 2003-001654 supposes a method for cleansing the support surface without decreasing the productivity. In this publication, a light beam is applied onto the support surface and the reflectivity is measured in order to know how much organic materials are adhered onto the support surface. If more than predetermined amount of the organic materials are adhered, the support surface is wiped continuously or intermittently with use of the nonwoven cloths to which the solvent is transfused.

However, even in the method of the publication No. 2003-001654, the cleaning of the support surface is made after the existence of the organic material is found out, and therefore it is not prevented that the amount of the organic materials increases on the film surface. Thus the quality of the produced film is low. Further, in the case that the support surface is cleaned with use of the solvent, a small amount of the solvent easily remains on the support surface, so as to cause the formation of the streak or unevenness on the support surface. Thus the smoothness of the film becomes lower. Furthermore, in the case that the support surface is wiped with use of the nonwoven cloth and the like, a hard foreign material sometimes enter between the nonwoven cloth and the support, to damage the support surface. In the case that the dope is cast onto the damaged support, the scratches are formed on the surface of the casting film, and thus the produced film has the optical nonuniformity.

### SUMMARY OF THE INVENTION

An object of the present invention is to provide a solution casting method for producing a high quality film without optical nonuniformity by decreasing the amount of organic materials adhered on the support and without decreasing the productivity.

In order to achieve the object and the other object, in a solution casting method, a dope containing a solvent and a polymer is cast onto a surface of an endless support so as to form a casting film, the casting film is peeled as a film from the support, and the surface of the support is cleaned after the peeling of the casting film before the next casting of the dope so as to remove an organic material adhered to the surface. Then the film is dried.

Preferably, the cleaning is made by blowing continuously or intermittently a cleaning gas against the surface of the support, with use of a blowing device, while the cleaning gas contains particles of dry ice and a carrier gas for carrying the dry ice particles.

Especially preferably, the cleaning gas is generated by mixing in a mixing section of the blowing deice the dry ice particles to a carrier gas for carrying the dry ice particles to the support, and the mixture section connects a first feeding section for feeding the dry ice particles to a second feeding section for feeding the carrier gas. A flow volume of the dry ice particles fed to the mixing section is measured by a first flow volume meter, and the first flow volume meter is disposed on a first pipe connecting the first feeding section to the mixing section. A flow volume of the carrier gas fed to the mixing section is measured by a second flow volume meter, and the second flow volume meter is disposed on a second pipe connecting the second feeding section to the mixing section. A feedback control of each of the flow volumes of the dry ice particles and the carrier gas is performed on the basis of measurements by the first flow volume meter and the second flow volume meter.

Especially preferably, the cleaning gas is generated by mixing in a mixing section of the blowing deice a liquid carbon dioxide to a carrier gas, the liquid carbon dioxide is to form the dry ice particles, and the carrier gas carries the dry ice particles to the support, and the mixture section connects a first feeding section for feeding the liquid carbon dioxide to a second feeding section for feeding the carrier gas. A flow volume of the liquid carbon dioxide fed to the mixing section is measured by a first flow volume meter, and the first flow volume meter is disposed on a first pipe connecting the first feeding section to the mixing section. A flow volume of the carrier gas fed to the mixing section is measured by a second flow volume meter, and the second flow volume meter is disposed on a second pipe connecting the second feeding section to the mixing section. A feedback control of each of the flow volumes of the liquid carbon dioxide and the carrier gas is performed on the basis of measurements by the first flow volume meter and the second flow volume meter.

Furthermore especially preferably, a pressure in the first pipe is measured by a pressure meter provided on the first pipe, and a feedback control of a feed pressure of the liquid carbon dioxide is performed on the basis of measurement by the pressure meter.

Furthermore especially preferably, a temperature of the liquid carbon dioxide in the first pipe is measured by a thermometer provided on the first pipe, and a feedback control of the temperature on the basis of measurement by the thermometer.

As a particularly preferable embodiment of the present invention, a glossiness of a support surface of the support is measured by a glossiness meter disposed in a downstream side from the blowing device in a running direction of the support, a real cleaning time which it takes to make the glossiness of the support surface to a predetermined value, and a blow volume of the cleaning gas is controlled on the basis of a measured value obtained by the glossiness meter and the real cleaning time.

Preferably, a UV ray is emitted continuously or intermittently toward the surface of the support in the cleaning. Preferably, a plasma is emitted continuously or intermittently toward the surface of the support in the cleaning. Preferably a laser beam is emitted continuously or intermittently toward the surface of the support in the cleaning.

Preferably, a temperature of the surface of the support is cooled to be in a range of −10° C. to 10° C. such that the casting film is gelatized to have a self-supporting property.

Preferably, the polymer is cellulose triacetate, and the organic material contains at least one of aliphatic acids, aliphatic acid esters and metal salts of aliphatic acids.

According to the present invention, the increase of amount of the organic solvent adhered on the surface of the support is reduced without the decrease of the casting speed by performing the cleaning of the surface of the support from the peeling of the casting film to the casting of the dope. Thus the high quality film having no optical unevenness can be produced without decreasing the productivity. Further, the cleaning is performed without scratching the periphery of the support.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production line of the present invention;

FIG. 2 is a schematic diagram illustrating a situation of cleaning the surface of a casting drum with use of a drum cleaning unit of the first embodiment;

FIG. 3 is a schematic diagram illustrating a situation of cleaning the surface of a casting drum with use of a drum cleaning unit of the second embodiment;

FIG. 4A is a graph illustrating a fluctuation of flow volume of a liquid carbon dioxide during a drum cleaning;

FIG. 4B is a graph illustrating a fluctuation of pressure to a liquid carbon dioxide during a drum cleaning;

FIG. 4C is a graph illustrating a fluctuation of temperature of a liquid carbon dioxide during a drum cleaning;

FIG. 5 is a graph illustrating a fluctuation of glossiness of a periphery of a casting drum during a drum cleaning;

FIG. 6 is a schematic diagram illustrating a situation of cleaning the surface of a casting drum with use of a drum cleaning unit of the third embodiment;

FIG. 7 is a schematic diagram illustrating a situation of cleaning the surface of a casting drum with use of a drum cleaning unit of the fourth embodiment; and

FIG. 8 is a schematic diagram illustrating a situation of cleaning the surface of a casting drum with use of a drum cleaning unit of fifth embodiment.

### PREFERRED EMBODIMENTS OF THE INVENTION

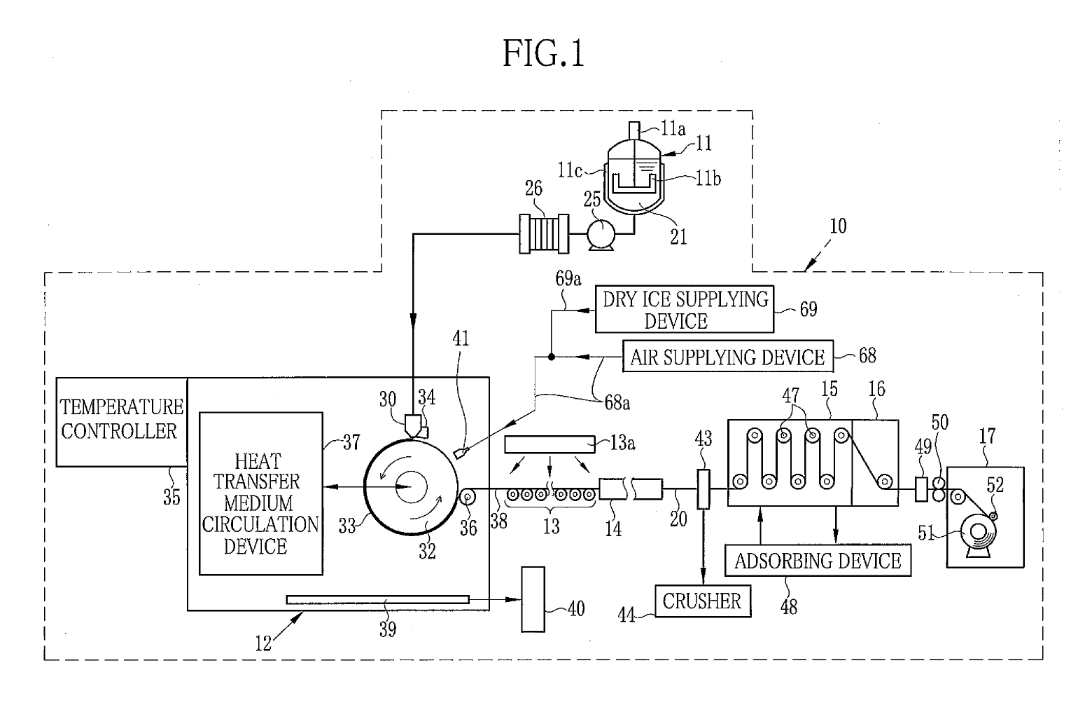

As shown in FIG. 1, a film production line 10 is constructed of a stock tank 11, a casting chamber 12, a transfer area 13, a pin tenter 14, a drying chamber 15, a cooling chamber 16, and a winding chamber 17.

The stock tank 11 is used for storing a dope 21 which is a row material of a film 20, and provided with a stirrer 11b to be rotated by a motor 11a and a jacket 11c which is used for adjusting an inner temperature of the stock tank 11. The jacket 11c is disposed so as to cover a periphery of the stock tank 11, and supplied with a heat transfer medium whose temperature is controlled to a predetermined value of the inner temperature of the jacket 11c. Thus the inner temperature of the jacket 11c is controlled in a predetermined range, and the temperature of the dope 21 stored in the stock tank 11 is kept almost constant. Further, the motor 11a is driven to rotate the stirrer 11b, and thus the dope 21 is continuously stirred. Therefore the aggregation does not occur, and the concentration and the quality of the dope 21 are kept uniform. Further, in the downstream side from the stock tank 11, there are a pump 25 and a filtration device 26. Note that the detailed explanation of the dope 21 will be made later.

In the casting chamber 12, there are a casting die 30, a casting drum 32 used as a support, a decompression chamber 34, a temperature controller 35, a roller 36, a heat transfer medium circulation device 37 connected to the casting drum 32, a drum cleaning unit 41 and a condenser 39 connected to a recovering device 40 which is disposed outside the casting chamber 12. The casting die 31 casts the dope 21 onto the casting drum 32 to form a casting film 33. The decompression chamber 34 decompresses an area near an outlet of the casting die 30. The roller 36 is used for peeling the casting film 33 as a wet film 38 from the casting drum 32.

The casting die 30 has an outlet from which the dope 21 is discharged, and the outlet is positioned so as to be close to the casting drum 32. Preferably, the casting die 30 is produced from a material which has the high corrosion resistance and the low thermal expandability to an electrolyte solution or a mixture of methanol, dichloromethane and the like. Further, it is preferable that the finish accuracy of the contact surface of the casting die 30 to the dope 21 is at most 1 μm in surface roughness, and that the straighthness in any direction is at most 1 μm in surface roughness. Thus the casting film 33 which has neither streak nor unevenness is formed on the casting drum 32.

The casting drum 32 has a cylindrical shaft (not shown) and rotated in an arrowed direction (hereinafter rotating direction) around the shaft by a driving device (not shown). The drum is cylinder hollow or cylinder, and the hard chrome plating is made on the surface in order to provide the sufficient corrosion resistance and the sufficient strength. In the casting drum 32, a path (not shown) of a heat transfer medium is formed. The heat transfer medium is supplied from the heat transfer medium circulation device 37 which is attached to the casting drum 32. Since the heat transfer medium is fed through the path circulatory, the surface temperature of the casting drum 32 is controlled to a predetermined value. Further, it is preferable to use a casting belt which is endlessly running and supported by support rollers, instead of the casting drum 32.

The decompression chamber 34 is disposed in an upstream side from the casting die 30 in the rotating direction, and decompresses to a predetermine value in an upstream side area from a dope bead formed by the discharged dope 21 between the casting die 30 and the casting drum 32. The upstream side area from the dope bead is a side of a dope surface which is to contact to the casting drum 32. The roller 36 supports the casting film 33 peeled from the casting drum 32. The condenser 39 condenses a gas including an organic solvent evaporated from the dope 21 and the casting film 33. Further a recovering device 40 recovers the condensed organic solvent. Note that the recovered solvent is reused as a solvent for the dope preparation after the recycling by a recycling device (not shown).

The drum cleaning unit 41 is disposed closely to the casting drum 32 in an area downstream from the peeling position of the casting film 33 and in an area upstream from the casting position of the dope 21. The drum cleaning unit 41 blows a predetermined cleaning gas toward a surface of the casting drum 32 to remove organic materials on the casting drum 32. The organic materials mainly contain aliphatic acids, aliphatic acid esters, or metal salts of the aliphatic acids. However, the organic materials are not restricted in them, but may be a product from the aliphatic acid contained in the polymer as the raw material of the film and an alcohol contained in the solvent or from the additives added during the dope preparation and the alcohol in the solvent. Note that part of the organic material on the casting drum 32 is sampled, and the analysis of the obtained sample is made by IR (infrared ray spectrophotometer), GCMS (gas chromatograph mass spectrometer), NMR (nuclear magnetic resonance spectrometer) and the like.

The cleaning gas is preferably a mixture of a dry ice particles and an air. However, instead of the air, the nitrogen or the inert gas may be used. The drum cleaning unit 41 is connected through a pipe 68a to an air supplying device 68 for supplying the air. The air supplying device 68 is provided with a pressure controller (not shown) and a timer (not shown) for controlling a time of supplying the air. During the time set with the timer, the air is supplied through the pipe 68a while the pressure controller controls the pressure of the air. The pressure controller preferably has a temperature controller for controlling a temperature of the air stored in a tank, for example. Further, the pipe 68a is combined with a pipe 69a which is connected to a dry ice supplying device 69. The dry ice supplying device 69 includes a timer and an adjusting device for adjusting a size (or particle diameter) and the supply rate of the dry ice, and supplies the dry ice particles through the pipe 69a during a predetermined time after the adjustment of the particle diameter.

In the transfer area 13 disposed between the casting chamber 12 and the pin tenter 14, there are a large number of rollers and an air blower 13a. The pin tenter 14 includes a plurality of pins for holding both side edge portions of the wet film 38, and dries the wet film 38 to the film 20.

Between the pin tenter 14 and the drying chamber 15, there is an edge slitting device 43 for slitting off both side edge portions of the film 20. The edge slitting device 43 is provided with a crusher 44 for crushing the tips of both side edge portions.

In the drying chamber 15, the film 20 is transported with lapping on many rollers 47. The solvent vapor evaporated from the film 20 by the drying chamber 15 is adsorbed and recovered by an absorbing device 48. The film 20 is transported into a cooling chamber 16, and cooled down. In the downstream side from the cooling chamber, there is a compulsory neutralization device (or a neutralization bar) 49 which eliminates the charged electrostatic potential of the film 20 to the predetermined value. Further, in this embodiment, there is a knurling roller 50 for providing a knurling to the film 20 in the downstream side of the compulsory neutralization device 49. In the winding chamber 17, there are a winding shaft 51 around which the film 20 is wound up, and a press roller 52 for pressing the film 20 to the winding shaft 51.

In followings, an example of a method of producing the film 20 with use of the film production line 10 will be explained. In the stock tank 11, the heat transfer medium is fed in the jacket 11c so as to control the temperature of the dope 21 in the range of 25° C. to 35° C. Further, the stirrer 11b is continuously rotated to make the concentration and the quality of the dope 21 uniform. The pump 25 is driven to feed an adequate amount of the dope 21 from the stock tank 11 to the filtration device 26 including a filter. Thus impurities are removed from the dope 21.

The casting drum 32 is continuously rotated at a predetermined rotation speed by the driving device. Further, the heat transfer medium is fed from the heat transfer medium circulation device 37 to the path in the casting drum 32, such that the surface temperature of the casting drum 32 may be in the range of −10° C. to 10° C. The dope 21 is discharged from the outlet of the casting die 30 for the casting onto the casting drum 32. At this moment, the temperature of the dope 21 is preferably in the range of 30° C. to 35° C. On the casting drum 32, the dope 21 is cooled down rapidly to form the gel-like casting film 33. While the casting film 33 is moved in accordance with the rotation of the casting drum 32, the casting film 33 cools down more over such that the gelation of the casting film 33 may proceed. Thus when the casting drum 32 whose surface temperature is cooled is used as the support, the casting film 33 obtains a self supporting properties in a short time, and therefore the productivity becomes higher. The casting film having the self supporting properties is peeled as the wet film with support of the roller 36.

The inner temperature of the casting chamber 12 is controlled to a predetermined value in the range of 10° C. to 30° C. by the temperature controller 35. Further, in this embodiment, the solvent vapor evaporated from the dope 21 and the casting film 33 in the casting chamber 12 is condensed by the condenser 39, recovered by the recovering device 40, and recycled as the solvent for the dope preparation by the recycling device.

In the transfer area 13, the wet film 38 contains a lot of solvent, and therefore dried by applying a drying air from the air blower 13a during the transfer of the wet film 38 in the transfer area 13.

In the pin tenter 14, many pins are inserted into both side edge portions near an entrance. Thus both side edge portions are held by the pins, and the wet film 38 is dried to the film 20 while transported in the pin tenter 14. Near the exit of the pin tenter 14, the pins are removed from both side edge portions of the film 20.

In the downstream side of the pin tenter 14, a clip tenter (not shown) may be provided for drying the film 20. The clip tenter is a drying device which includes a plurality of clips as clipping member of both side edge portions of the film 20. Each clip is attached to an endless chain which is continuously running, and moves in accordance with the running of the chain. In the clip tenter, both side edge portions are clipped by the clips, and the film 20 is dried while transported in the clip tenter. Further, during the transportation in the clip tenter, the distance between the confronting clips may be made wider such that the film 20 may be stretched in a widthwise direction. Thus the orientation of the molecules is controlled such that the film 20 may have a predetermined retardation value. Just before the sending of the film 20 to the clip tenter, the content of remaining solvent in the film 20 is preferably in the range of 50 wt. % to 150 wt. %. The content of the remaining solvent is the weight percentage of the solvent remaining in the film 20 on the dry basis. If the sample weight of the casting film 33 is x and the sample weight after the drying is y, the solvent content on the dry basis (%) is calculated in the formula, {(x−y)/y}×100.

The film 20 is fed to the edge slitting device 43, and both side edge portions are slit off. The tips of the both side edge portions are crushed. Then the film 20 is conveyed through the drying chamber 15 and the cooling chamber 16 to the winding chamber 17 in which the film 20 is wound around the winding shaft 51. Note that the tips crushed by the crusher 44 are reused as tips for the dope preparation.

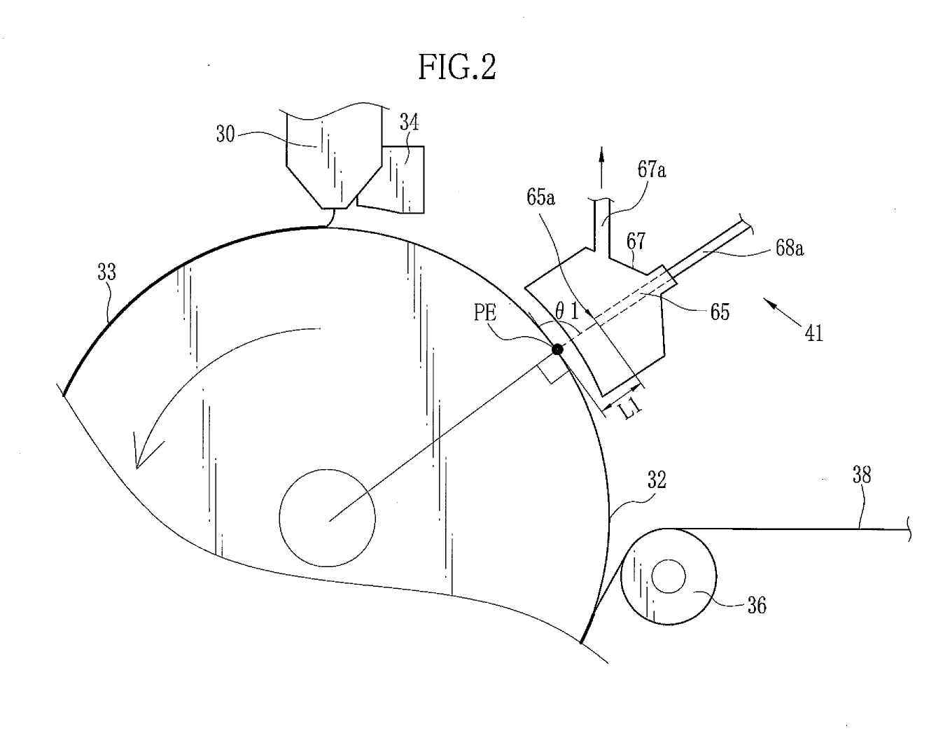

As shown in FIG. 2, the drum cleaning unit 41 is constructed of a nozzle 65 attached at an end of the pipe 68a, and an aspiration cover 67 provided around the nozzle 65. The aspiration cover 67 is attached to an aspiration tube 67a for connecting an aspiration device (not shown). Thus the aspiration device aspirates the air around the nozzle 65 with use of the aspiration cover 67. Further, the drum cleaning unit 41 is connected to a shift device (not shown). The drum cleaning unit 41 is positioned such that an outlet 65a of the nozzle 65 may be apart from the casting drum 32 at a distance L1 and form an angle θ1 of a blowing direction to the casting drum 32 in an downstream side. The distance L1 and the angle θ1 are controlled adequately, such that the cleaning gas may blow against the surface of the casting drum 32 efficiently.

The cleaning gas is fed through the pipe 68a to the nozzle 65 and blows from the outlet 65a of the nozzle 65. The dry ice particles in the cleaning gas collide against the surface of the casting drum 32 to shatter the organic materials which is adhered to the surface. In this embodiment, the casting drum 32 is cooled such that the temperature of the surface may be in the predetermined range, and therefore the dry ice can collide without sublimation. Further, after the colliding, the dry ice particles melt to the carbon dioxide of a liquid state because of the colliding energy by shattering. The carbon dioxide in the liquid state dissolves the organic materials, covers over them, and evaporates in the situation that the organic materials are contained. While the organic solvent is broken and removed, the air around the cleaning area is aspirated with use of the aspiration cover 67. Thus the broken organic materials scattering and flying in the air is aspirated. Therefore, it is prevented that the broken organic materials adhere to a film surface of the casting film 33. Note that the aspiration force is not restricted especially if it is smaller than the blowing pressure of the cleaning gas.

The blowing of the cleaning gas to the casting drum 32 is made after the peeing the casting film 33 and before the casting the dope 21. Thus the cleaning gas blows to the organic materials just after the precipitation. As a result the organic materials are effectively broken and removed at high efficiency before the increase of the amount thereof. If the blowing is made intermittently, the blowing is made at least once after the peeing the casting film 33 and before the casting the dope 21. However, the number of times is not restricted but may be determined adequately. Further, the blowing is made intermittently or continuously. Which blowing method is to be chosen, it depends on the estimated amount of the organic materials which are to adhere to the surface of the casting drum 32. The amount of the precipitation can be estimated on the basis of the composition of the dope, the surface temperature of the casting drum 32 and the like. For example, in the case that the casting is made with use of the dope from which the precipitation amount of the organic materials is expected to be large, it is effective that the blowing continuously made. In the case that the casting is made with use of the dope from which the precipitation amount is expected to be small, the blowing may be made intermittently. Thus the productivity becomes larger and the cost for the blowing is reduced, or both of them are well-balanced.

The effects of shattering the organic materials can be increased by adjusting the distance L1 between the outlet 65a and the casting drum 32, the blowing pressure of the cleaning gas, and an average diameter of the dry ice particles. The distance L1 is preferably in the range of 0.1 mm to 15.0 mm, particularly in the range of 0.1 mm to 10.0 mm, and especially in the range of 0.1 mm to 2.0 mm. The distance L1 is the same as the moving length of the cleaning gas left from the outlet 65a to the casting drum 32. If the distance L1 becomes larger over 15.0 mm, the dry ice particles sometimes sublime before approaching to the surface of the casting drum 32, and it is more difficult to keep the shattering energy for shattering the organic materials. Otherwise, the distance L1 becomes smaller below 0.1 mm, the smashing energy becomes too large, and therefore it is hard to blow continuously and to dispose the devices. Note that the distance L1 may be determined adequately on the basis of the easiness of the deposition, so far as the above ranges which are effective to the smashing are satisfied.

The blowing pressure is preferably in the range of 600 kPa to 4000 kPa, and particularly in the range of 1000 kPa to 2500 kPa. In the case that the blowing pressure is more than 4000 kPa, the nozzle 65 is sometimes stopped by the dry ice particles, and the scratches are formed by the blowing. If the blowing pressure is less than 600 kPa, the shattering energy at the colliding of the cleaning gas may be too small to smash the organic materials. Further, the average diameter of the dry ice particles is preferably in the range of 5 μm to 20 μm. In the case that the average diameter is more than 20 μm, it may be too large and therefore the scratches may be sometimes formed on the surface of the casting drum 32. Further, in the case that the average diameter may is than 5 μm, it may be too small, and therefore the effect for smashing may be decreased. Note that the diameter of the dry ice particles is preferably chosen adequately in accordance with the size of the organic materials.

Further, in order to increase the shatter the organic material, it is preferable to control the blowing time of the cleaning gas and the angle θ1 of a blowing direction to the casting drum 32 in a downstream side. In this figure, a crossing point of an extending line from the nozzle 65 and the drum 32 is described as a point PE, and a tangent line on a drum surface in a rotary direction of the drum 32 is drawn at the point PE. The tangent line upstream from the point PE in the rotary direction of the drum 32 has an angle θ1 to the extending line from the nozzle 65. The blowing time is preferably in the range of 1×10⁻³ seconds to 5 seconds, and particularly preferably in the range of 1×10⁻² seconds to 5 seconds. If the blowing time is more than 5 seconds, the scratches are sometimes formed on the surface of the casting drum 32. If the blowing time is less than 1×10⁻³, it is too hard to smash the organic materials. Further, the angle θ1 is preferably in the range of 45° to 135°, particularly preferably in the range of 70° to 110°, and especially preferably in the range of 85° to 95°. The angle θ1 is controlled in accordance with the shape and the like of the organic materials. The method of blowing the dry ice particles is applied as a method of cleaning the surface of the casting drum under the explosion protection.

The number of the drum cleaning unit 41 is not restricted especially, and not only one but also a plurality of the drum cleaning unit 41 may be used. In the case that a plurality of the drum cleaning unit 41 is used, they may be arranged in the widthwise direction of the casting drum, and otherwise disposed on the basis of the estimation of the positions at which the organic materials would be adhered, by performing the casting of the dope on a small scale. If the number of the drum cleaning unit 41 is one, the drum cleaning unit 41 may be a scanning type, in order to obtain the effects for shattering the organic material in a wide range.

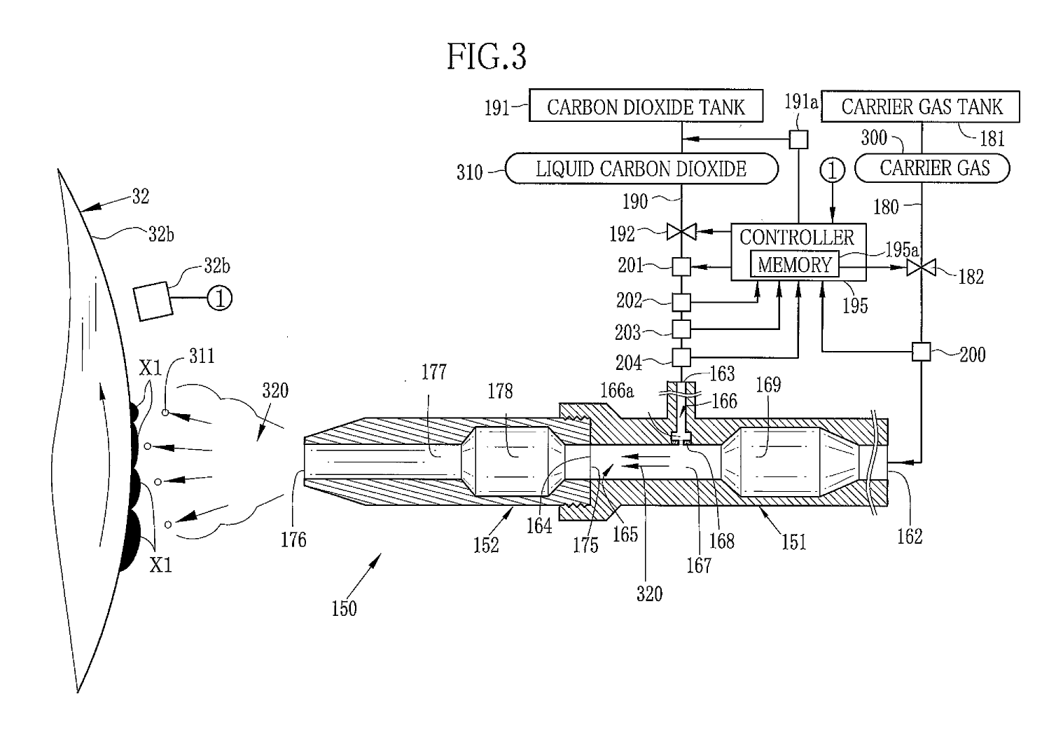

The above device for supplying the cleaning gas in which the dry ice particles and the air are mixed is not restricted especially. For example, the carbon dioxide in the liquid state may be sprayed to form the dry ice particles, and thus the cleaning gas is blown against the casting drum 32. In FIG. 3, a drum cleaning unit 150 is a type of spraying the carbon dioxide in the liquid state. In the downstream side from the drum cleaning unit 150 in the running direction, there is a glossiness measuring device 198 for measuring the glossiness of the periphery 32b of the casting drum 32.

The drum cleaning unit 150 includes a first nozzle 151 and a second nozzle 152. The first nozzle 151 includes a carrier gas inlet 162, a carbon dioxide inlet 163, a downstream end 164, and a first passage 165 combining the carrier gas inlet 162 to the downstream end 164, and a carbon dioxide path 166 connected the carbon dioxide inlet 163 to the first passage 165. Into the first nozzle 151 a carrier gas 300 is fed through the carrier gas inlet 162, and a liquid carbon dioxide 310 is fed through the carbon dioxide inlet 163. The first passage 165 has a connect portion 167 at which the carbon dioxide path 166 is connected to the first passage 165. In the connect portion 167, the liquid carbon dioxide 310 fed through the carbon dioxide path 166 is mixed with the carrier gas 300, so as to form dry ice particles 311, and the mixture of the carrier gas 300 and the dry ice particles 311 is called a cleaning gas 320. The cleaning gas 320 is fed through the downstream end 164 from the first nozzle 151. Further, the carbon dioxide path 166 is provided with an orifice 168 at a downstream end 166a thereof. Further, the first passage 165 has a pocket 169 disposed in an upstream side from the connect portion 167. The cross section area of the pocket 169 is larger than that of the first passage 165. In the pocket 169, a flow of the carrier gas 300 is rectified.

The second nozzle 152 has an upstream end 175, a cleaning gas outlet 176, and a second passage 177 formed from the upstream end 175 to the cleaning gas outlet 176. The upstream end 175 of the second nozzle 152 is fitted to the downstream end 164 of the first nozzle 151, such that the first nozzle 151 and the second nozzle 152 may be connected. The cleaning gas 320 fed out through the first passage 165 of the first nozzle 151 enters through the upstream end 175 into the second passage 177 of the second nozzle 152, and fed out through the cleaning gas outlet 176 toward the casting drum 32. Further, the second passage 177 has a pocket 178. The cross section area of the pocket 178 is larger than that of the second passage 177. In the pocket 178, a flow of the carrier gas 300 is rectified.

The drum cleaning unit 150 is disposed such that the distance L1 and the angle θ1 to the periphery 32b of the casting drum 32 may be predetermined values. Note that the disposition conditions (the distance L1 and the angle θ1) of the drum cleaning unit 150 to the casting drum 32 may be the same as the former embodiment, and therefore the detailed explanations thereof will be omitted.

The carrier gas inlet 162 is connected through a pipe 180 with a carrier gas tank 181 as a source of the carrier gas 300. A pipe disposed in a downstream side from the carbon dioxide gas tank 191 is provided with a pressure controller 191a for controlling a pressure of the liquid carbon dioxide 310. The pipe 180 is provided with a valve 182 for adjusting a flow volume of the carrier gas 300. The carbon dioxide inlet 163 is connected through the pipe 190 with a carbon dioxide tank 191 as a source of the liquid carbon dioxide 310. The pipe 190 is provided with a valve 192 for adjusting a flow volume of the liquid carbon dioxide 310. Further, the pipe 180 is provided with a flow meter 200, the pipe 190 is a temperature controller 201, a flow meter 202, a pressure sensor 203 and a temperature sensor 204.

As the carrier gas 300, for example an air is used. The carrier gas 300 may be stored under a compressed situation to a predetermined pressure in the carrier gas tank 181. The liquid carbon dioxide 310 preferably has a high purity. Further, the carbon dioxide tank 191 and the pipe 190 preferably has capability to keep in the liquid state the liquid carbon dioxide 310 fed out from the carbon dioxide tank 191, until the liquid carbon dioxide 310 is supplied into the connect portion 167.

The open- and closing of the valves 182, 192 are controlled by a controller 195 which is provided with a memory 195a. The controller 195 controls the flow volumes of the carrier gas 300 and the liquid carbon dioxide 310, the pressure to the liquid carbon dioxide 310 in the pipe 190, and the temperature of the liquid carbon dioxide 310 to the respective most predetermined values at which the efficiency of the cleaning may be the best. These most predetermine values of the flow volumes, the pressure and the temperature are memorized in the memory 195a. Further, the degree of the glossiness of the periphery 32b of the casting drum 32 and the cleaning time corresponding to the degree of glossiness for cleaning the periphery 32b are memorized in the memory 195a. Note that the glossiness is a barometer for how much the cleaning proceeds. When the aperture ratio of the valves 182, 192 is controlled, the blowing pressure of the cleaning gas, the particle diameters of the dry ice particles, the mixture rate of the carrier gas 300 and the liquid carbon dioxide 310 are adjusted.

The controller 195 adjusts the aperture ratio of the valves 182, 192 on the basis of the flow volumes of the carrier gas 300 and the liquid carbon dioxide 310 while the flow volumes are measured by the flow meters 200, 202. Thus the flow volumes of the carrier gas 300 and the liquid carbon dioxide 310 are made to be close to the most adequate values. In following, this method is called a feedback control of the flow volumes of the carrier gas 300 and the liquid carbon dioxide 310. The feedback control reduces the problem that the dry ice stops the first and second nozzles 151, 152 of the drum cleaning unit 150. Thus the efficiency of the cleaning is kept.

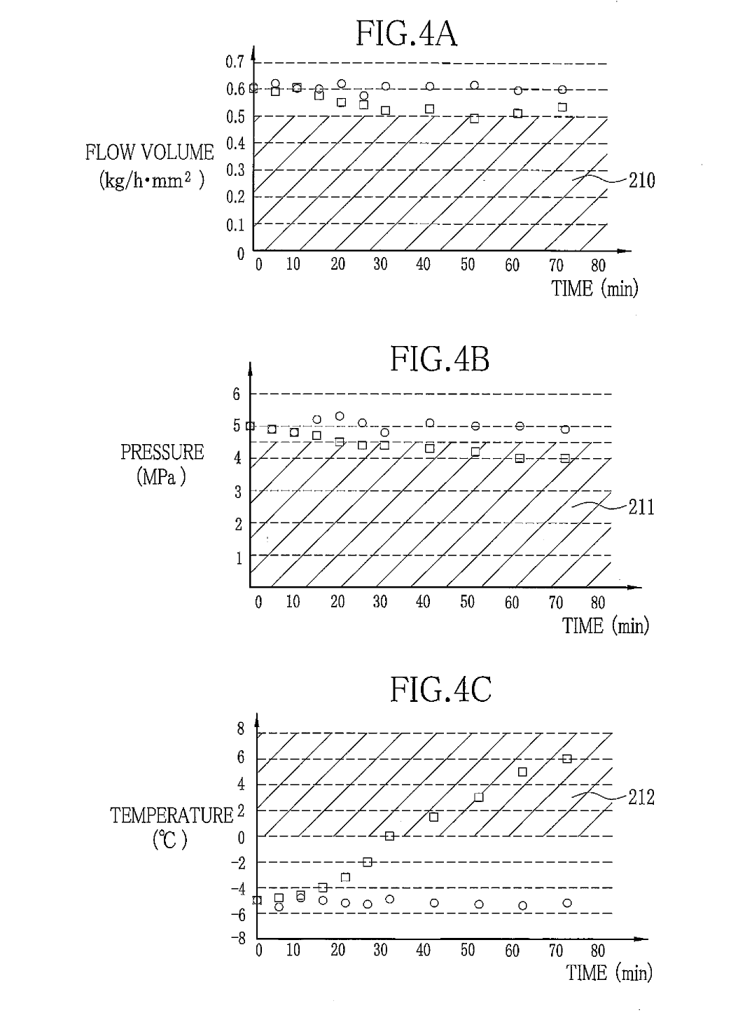

FIG. 4A shows the change in the flow volumes of the liquid carbon dioxide 310 with time during the drum cleaning. The vertical line shows a flow volume (kg/h·mm²) and the transverse axis shows a time. The circular indication ◯ indicates the flow volume of the carbon dioxide when the feedback control is performed. The rectangular indication □ indicates the flow volume of the carbon dioxide when the feedback control is not performed. Further, in a hatching area 210, the flow volume when the efficiency of the cleaning is low. According to this figure, when the feedback control is made, the flow volume of the carbon dioxide is almost constant even after the long performance of the cleaning.

The pressure in the pipe 190 is measured by the pressure sensor 203, and on the basis from the measured value of the pressure, the controller 195 controls a pressure adjusting device 191a. Thus the supply pressure of the carbon dioxide tank 191 is adjusted, such that the pressure in the pipe 190 may be close to the most adequate value. Further, the carbon dioxide tank 191 is too cold to reduce the inner pressure thereof. However, in the present invention, since the feedback control of the pressure in the pipe 190 is made in this manner, the decrease of the inner pressure of the carbon dioxide tank 191 is reduced. Thus the supply pressure of the liquid carbon dioxide 310 is kept uniform, and therefore the efficiency of the cleaning is kept.

FIG. 4B shows the change of in the pressure to the liquid carbon dioxide 310 in the pipe 190 with time during the drum cleaning. The vertical line shows a pressure of CO₂ in the pipe 190, and the transverse axis shows a time (min). The circular indication ◯ indicates pressure in the pipe 190 when the feedback control is performed, and the rectangular indication as shown with □ indicates the pressure in the pipe 190 when the feedback control is not performed. Further, in a hatching area 211, the efficiency of the cleaning is low. According to this figure, when the feedback control is made, the pressure in the pipe 190 is almost constant even after the long performance of the cleaning.

The temperature of the liquid carbon dioxide 310 in the pipe 190 is measured by the temperature sensor 204, and on the basis of the measured value of the temperature, the controller 195 controls a temperature adjusting device 201. Thus the temperature of the liquid carbon dioxide 310 may be close to the most adequate value. For example, the inner temperature of the pipe 190 increases in the summer, and otherwise the cooling ability sometime changes. In these cases, the temperature of the liquid carbon dioxide 310 increases, and therefore the cleaning becomes hard. However, in the present invention, since the feedback control of the temperature of the liquid carbon dioxide 310 is made, the temperature of the liquid carbon dioxide 310 is kept almost uniform. Thus the efficiency of the cleaning is kept. Note that the most adequate temperature of the liquid carbon dioxide 310 is preferably −5° C. at which the vaporization rate is at the highest. Further, the feedback control of the temperature of the liquid carbon dioxide 310 is effectively made when the drum cleaning unit 150 is driven continuously for more than 10 minutes.

FIG. 4C shows the change in the temperature of the liquid carbon dioxide 310 with time during the drum cleaning. The vertical line shows a pressure of CO₂ in the pipe 190, and the transverse axis shows a time (min). The circular indication as shown with ◯ indicates the temperature of the carbon dioxide when the feedback control is performed. The rectangular indication □ indicates the temperature of the liquid carbon dioxide 310 when the feedback control is not performed. Further, in a hatching area 222, the efficiency of the cleaning is low. According to this figure, when the feedback control is made, the temperature of the carbon dioxide is almost constant even after the long performance of the cleaning.

The controller 195 drives the drum cleaning unit 150 so as to complete the cleaning until the glossiness of the casting drum 32 becomes to a value memorized in the memory 195a. Then in the controller 195, the real cleaning time which it takes for cleaning the casting drum 32 is compared with the memorized cleaning time memorized in the memory 195a in accordance with the predetermined glossiness. In the case that the real cleaning time is longer than the memorized cleaning time, the valves 182, 192 are opened more, such that the flow volumes of the carrier gas 181 and the liquid carbon dioxide 310 may be larger. Thus the blowing volume of the cleaning gas 320 is increased, and therefore the cleaning is made more effectively. Note that the flow volume of the liquid carbon dioxide 310 is preferably 120 kg/h·mm² in normal situation and 150 kg/h·mm² in a situation that the effective of the cleaning is increased. Further, the flow volume of the carrier gas 300 is preferably 5 m³/min·mm² in the normal situation and 6.5 m³/min·mm² in a situation that the effective of the cleaning is increased.

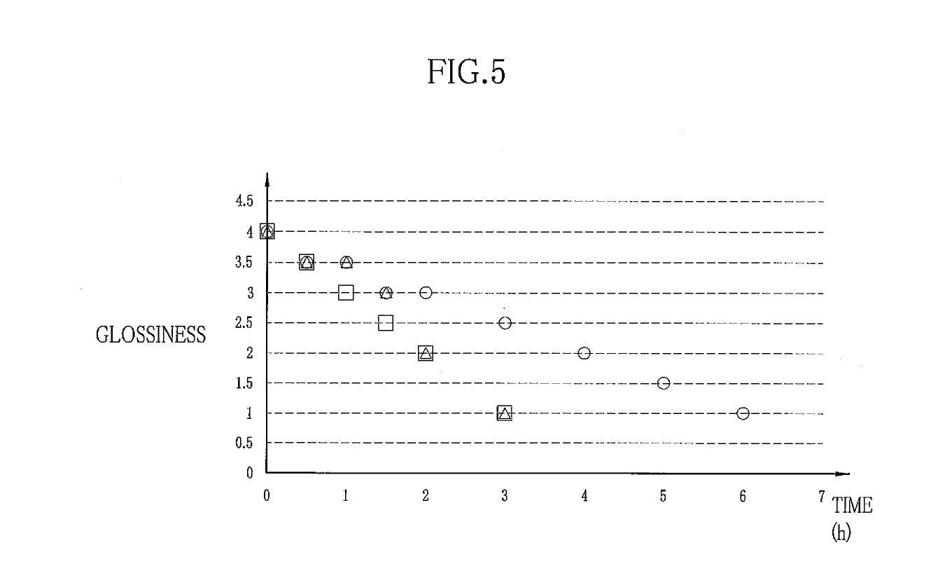

FIG. 5 shows the change in the glossiness of the periphery 32b of the casting drum 32 on time during the drum cleaning. The vertical line shows the glossiness, and the transverse axis shows a time (hour). When the glossiness is 1, the periphery 32b is the most brilliant, and when the glossiness is 4.5, the periphery 32b is the least brilliant. The circular indication as shown with ◯ indicates the glossiness when the feedback control is not performed. The triangle indication Δ indicates the glossiness when the feedback control is performed. The rectangular indication □ indicates the glossiness which is memorized in the memory 195a. In this figure, it takes long time that the glossiness changes from “3.5” to “3”, and the controller 195 detects that the real cleaning time is longer than the memorized cleaning time. Then the controller 195 opens the valves 182, 192 moreover, such that the effectives of the cleaning may become larger. Thus the cleaning time becomes shorter to be the memorized cleaning time.

The effects of the drum cleaning unit 150 will be explained. The controller 195 controls the aperture ratio of the valves 181, 191 adequately. The carrier gas 300 is fed at a predetermined flow volume Q1 (m³/mm·min) from the carrier gas tank 181 through the pipe 180 to the carrier gas inlet 162, and passes through the first passage 165 to the connect portion 167. The liquid carbon dioxide 310 is fed at a predetermined flow volume Q3 (m³/mm·min) from the carbon dioxide tank 191 through the pipe 190 to the carrier gas inlet 163, and passes through the carbon dioxide path 166 and the orifice 168 to the connect portion 167. Then, in the connect portion 167, the phase change of the liquid carbon dioxide 310 occurs, such that the liquid carbon dioxide 310 may form the dry ice particles 311 and carbon dioxide gas, which are contained with the carrier gas 300 in the cleaning gas 320. At the blowing of the cleaning gas 320, the dry ice particles 311 attack and smash to organic materials X1 on the periphery 32b of the casting drum 32, so as to remove the organic materials X1 from the periphery 32b.

The drum cleaning unit 150 performs the feedback controls of the feed volume of the carrier gas 300 and the liquid carbon dioxide 310, that of pressure in the pipe 190, and that of the temperature of the liquid carbon dioxide 310, so as to keep the effectives of the cleaning of the periphery 32b of the casting drum 32. Further, the real cleaning time which it takes for cleaning the casting drum 32 is measured until the glossiness becomes to a predetermined value. If the real cleaning time is longer the memorized cleaning time memorized in the memory 195a, the controller 195 controls the drum cleaning unit 150 such that the effectives of the cleaning may be larger.

The blowing of the cleaning gas 320 to the periphery 32b has effects as follows:
(1) the dry ice particles 311 attack and shatter the organic material X1 such that the kinetic energy of the dry ice particles 311 is utilized to destroy the organic material X1 adhered on the periphery 32b;
(2) by the attack, the phase change occurs such that the dry ice particles 311 may melt to a carbon dioxide in a liquid state;
(3) the carbon dioxide in the liquid state and the dry ice particles make evaporation such that the volume expansion may occur, and the volume expansion is effective to blow off the organic material X1;
(4) a total effects as a combination of the above (1)-(3). In effects of the collision of the dry ice particles, the organic materials X1 removed from the periphery 32b is miniaturized and circulated with the atmosphere gas, and there are no case that a remaining part of the organic material X1 causes the thickness unevenness and the defects of the occurrence of the precipitation. Further, if some of the organic material X1 remains on the periphery 32b, the amount thereof is too small to cause the defect of the occurrence of the precipitation.

In the second embodiment of FIG. 3, the flow volume of the liquid carbon dioxide 310 is measured for performing the feedback control. However, instead thereof, the flow volume of the dry ice particles 311 may be measured for making the feedback control.

In the second embodiment, the drum cleaning unit 150 constructed of the first nozzle 151 and the second nozzle 152 is described in the above description. However, the present invention is not restricted in it. For example, only the first nozzle 151 may be used as a drum cleaning unit. Further, near the drum cleaning unit 150, an adsorption duct (not shown) is preferably disposed so as to aspirate the broken organic materials and the like.

In order to remove of the organic materials adhered to the casting drum 32, an UV ray, an oxygen radical and a laser are used effectively. Then, the third embodiment of the present invention will be described in followings with reference to FIG. 4, in which the UV ray is used for the removal of the organic materials. Note that the explanation thereof will be made only in the different points from the first embodiment, and the same explanation will be omitted.

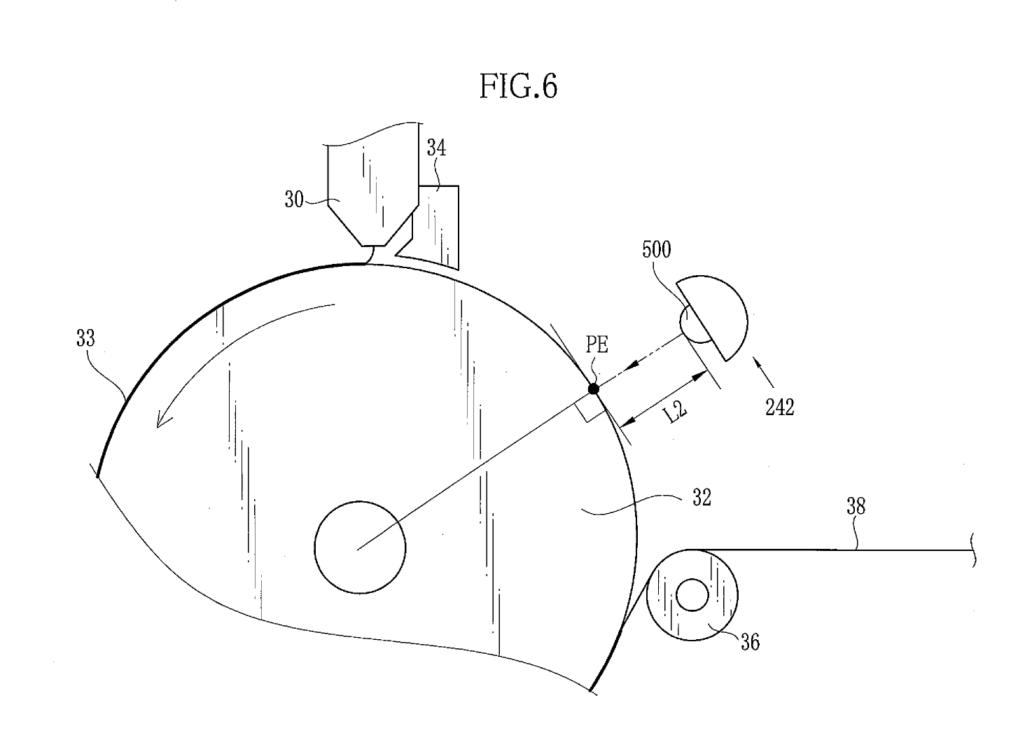

As shown in FIG. 6, a drum cleaning unit 242 includes a ultra violet (UV) lamp 500 which is a low pressure mercury lamp, and a built-in controller (not shown). The UV beam generated from the UV lamp 500 has two strong line spectra at 185 nm and 254 nm. If necessary, the UV ray is emitted from the UV lamp 500 to the casting drum 32. Note that the UV lamp is not restricted in this description, and may be an excimer lamp which can emit the UV ray of 172 nm, a high pressure mercury lamp, a metal halide lamp or the like.

The UV lamp 500 is connected with the built-in controller which is provided with a timer. The UV lamp 500 is set into the ON state or the OFF state on the basis of a predetermined emission time with the controller. When the emission of the UV ray is made, the UV lamp 500 is set into the ON state so as to emit the UV ray to the casting drum 32 from on the basis of the predetermined emission time. The UV lamp 500 of the low pressure mercury lamp is characteristic in that the line spectrum is strong at the wavelength of 185 nm and 254 nm, and each of the energy is 155 kcal/mol at 185 nm and 113 kcal/mol at 254 nm. Otherwise, the single bond energies of C—C, C—H, C═C, O—H and C—O as main bonds for constructing the above organic materials are respectively 84.3 kcal/mol, 97.6 kcal/mol, 140.5 kcal/mol, 110.6 kcal/mol, and 74.6 kcal/mol. Therefore, when the UV ray is emitted to the organic materials as the aliphatic esters, the bonds of the low energy in the organic materials are broken in effects of the UV ray, and thus the decomposition of the organic materials adhered on the casting drum 32 is made.

During the emission, the oxygen molecules in the casting chamber 12 absorb the UV ray of 185 nm to form ozone molecules. Further, the ozone molecules absorb the UV ray of 254 nm to form oxygen atoms O (¹D) in the exited state. Further, the ozone molecules sometimes pyrolyze to oxygen atoms (³P) in the ground state. The two types of the oxygen atoms ¹D, ³P having the strong oxidizability and the UV ray decompose the aliphatic acid esters adhered on the casting drum 32, such that CO₂, CO, H₂O, and low molecular compound may be produced. In order to absorb and recover these compounds, it is preferable to dispose an adsorption duct (not shown) near the UV lamp 500. Note that the above products are recovered by the condenser 39 in the casting chamber, and the low molecular compound is dissolved to the dope 21, and therefore contained in the dope 21. Thus the quality of the produced film 20 does not be lower. Note that when the predetermined emission time has passed, the built in controller sets the UV lamp 500 into the OFF state, and thus the emission of the UV ray is stopped.

The oxygen molecules which are to form ozone molecules in the emission of the UV ray may be those which are positioned in the casting chamber is performed or has entered into the casting chamber from the outside. In this embodiment, in order to remove the organic materials adhered onto the casting drum 32, the UV ray of the 185 nm and 254 nm is emitted. However, the present invention is not restricted in it, and the UV ray of any wavelength may be omitted to obtain the same effects, so far as it can break the bond in the organic materials such as the aliphatic acid esters. In this point, the wavelength of the UV ray may be 172 nm.

The effects of removing the organic materials by the emission of the UV ray depends on a distance L2 between the UV lamp 500 and the casting drum 32, the emission time, and the surface temperature of the casting drum 32. In the present invention, the distance L2 is preferably in the range of 25 mm to 50 mm, and particularly preferably in the range of 25 mm to 30 mm. In the case that the distance L2 is less than 25 mm, the surface temperature of the casting drum 32 increases in the emission of the UV lamp 500, which may disturb to keep the peelability of the casting film 33. In the case that the distance L2 is more than 50 mm, the decomposition of the organic materials such as the aliphatic ester is not made enough.

The emission time of the UV ray is preferably in the range of 60 minutes to 180 minutes, and particularly preferably in the range of 120 minutes to 180 minutes. If the emission time is 120 minutes, the effects of removing the organic materials are enough. In the case that the emission time is less than 60 minutes, it may be difficult to decompose the organic materials sufficiently. In the case that the emission time is more than 180 minutes, the effects of removing the organic materials may not increase, which may increase the cost in vain.

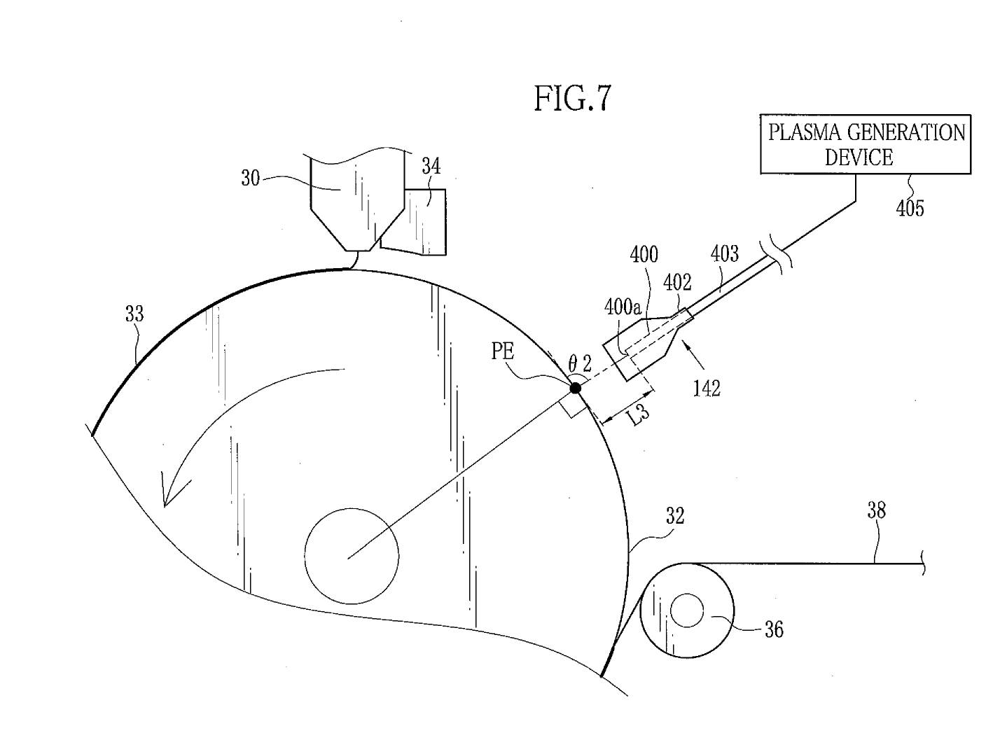

In the following, the fourth embodiment will be explained in reference with FIG. 7, in which the oxygen radical is used for cleaning the surface of the support. Note that the same explanation will be omitted as the first embodiment.

As shown in FIG. 7, a drum cleaning unit 142 is constructed a nozzle 400 attached in an end of a tube 403, and an aspiration cover 402 covering over a periphery of the nozzle 400. In the end of the nozzle is formed an outlet 400a which is opening to he casting drum 32. The aspiration cover 402 preferably has aspirating functions for aspirating near the outlet 400a. Further, the nozzle 400 is provided with a shift member for shifting the nozzle 400 to an adequate position, and thus a distance L3 from the outlet 400a to the casting drum 32 and the like are adjusted adequately. Further, the tube 403 is connected to a plasma generation device 405.

The plasma generation device 405 includes a gas chamber and timer (not shown). The gas chamber is filled with a predetermined gas containing oxygen, and provided with an electrode pair therein. The timer is used for generating and discharging the oxygen radical for a predetermined time. In the gas filling chamber, a predetermined voltage is applied between the pair of the electrodes, so as to generate the oxygen radicals from the oxygen molecules contained in the gas. Then the oxygen radicals are fed through the tube 403 to the drum cleaning unit 142, and discharged to the surface of the casting drum 32 from the outlet 400a for the predetermined time.

The discharged oxygen radicals make reaction with the organic materials adhered to the casting drum 32. Thus the oxygen materials whose main compounds are the aliphatic acid esters and the like decompose such that CO₂, CO, H₂O, and low molecular compound may be produced. These products are efficiently removed. In effects of discharging the oxygen radicals, other organic materials, such as the aliphatic acids and the metal salts thereof and the like, also decompose effectively. The materials as the products of the reactions with the oxygen radicals are recovered by the aspiration cover 402 and the condenser 39 with the organic solvent vapor in the casting chamber 12. Further, the low molecular compounds don't damage the film since being to dissolve to the dope 21 which is used for forming the casting film 33. Note that the oxygen molecules used for generating the oxygen radicals is in the casting chamber or may be supplied into the casting chamber from the outside.

The effects of decomposition or break of the organic materials by discharging the oxygen radical depend on the distance L3 and an angle θ2 of a discharging direction to the casting drum 32 in an upstream side. In the present invention, the distance L3 is preferably in the range of 2 mm to 15 mm, and particularly in the range of 2 mm to 5 mm. In the case that the distance L3 is less than 2 mm, the outlet 400a of the nozzle 400 may be too close to the casting drum 32, and therefore the casting drum 32 is sometimes damaged. Further, the nozzle 400 has the high temperature (250° C. to 350° C.). Therefore, in the case that the nozzle 400 is close to the casting drum 32, the temperature of the casting drum 32 may increase too much. In this case, the heat hysteresis sometimes causes the deterioration of the drum surface, and the temperature difference of the drum surface sometimes causes the change of the film thickness and the like. Otherwise, if the distance is larger than 15 mm, the oxygen radical doesn't reach the surface of the casting drum 32 enough, and therefore the effect of the decomposing the aliphatic acid esters by the oxygen radical is not enough.

The angle θ2 is preferably in the range of 30° to 150° particularly preferably in the range of 45° to 135°, and especially preferably in the range of 85° to 95°. In the case that the angle θ2 is closer to 90°, the effects of discharging the oxygen radical becomes larger. Further, the discharging time of the oxygen radicals to the casting drum 32 is preferably in the range of 0.025 seconds to 0.05 seconds, and particularly preferably in the range of 0.0375 seconds to 0.05 seconds. In the case that the discharging time is in the range of 0.025 seconds, the effects of the decomposition of the aliphatic acid esters on the casting drum 32 is observed. Otherwise, the discharging time is sufficient with 5 seconds in order to decompose all of the aliphatic materials on the casting drum 32.

In the above embodiment, the oxygen radical is generated by the plasma generation device 405 provided outside the casting chamber. However, the present invention is not restricted in it. For example, the oxygen in the casting chamber 12 may be used for the generation of the oxygen radical to discharge toward the casting drum 32, by which the same effect can be obtained.

In the present invention, the film production line is not stopped and the production speed is not decreased during the cleaning. Therefore the film of the high quality can be produced without the decrease of the productivity. Further, as in the above embodiments, when the drum cleaning unit of the non-contact type is used, the organic materials are removed without generating the scratches and the cleaning trance on the casting drum. The drum cleaning unit adequate for the present invention is not restricted in the above embodiment.

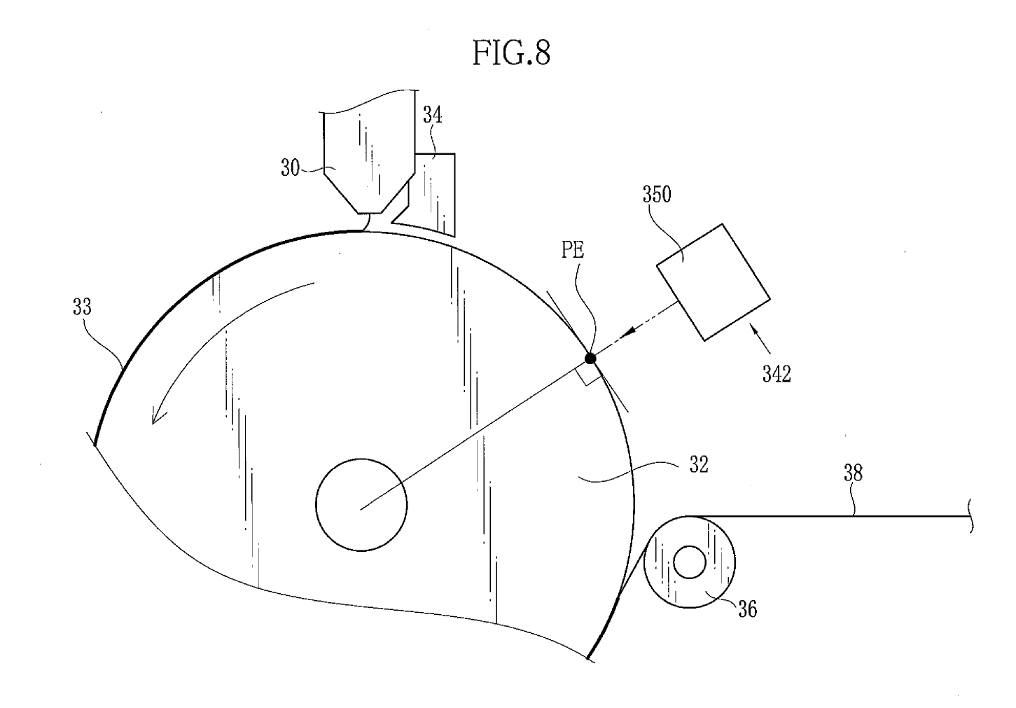

As shown in FIG. 8, a drum cleaning unit 342 includes a laser emitting device 350. When the cleaning is performed, the laser emitting device 350 emits a UV ray so as to make the laser irradiation on the drum 32.

In the present invention, the drum cleaning unit may include the non-woven cloth. In this case, however, it is preferable that the drum cleaning unit of this type is used with that of the non-contact type. Furthermore, in the above embodiments, the drum cleaning unit is disposed inline in the film production line. However, in the present invention, the drum cleaning unit is disposed outline from the film production line. In this case, the casting drum is removed from the film production line, in order to make the cleaning in the same manner.

The dope to be used in the present invention will be explained in the following.

As polymer of this embodiment, the already known polymer to be used for the film production may be used. For example, cellulose acylate is preferable, and triacetyl cellulose (TAC) is especially preferable. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7.

According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

The cellulose as the raw material of the cellulose acylate may be obtained from one of the pulp and the linter, and preferably from the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the dope bead between a die slit (or die lip) and the support that the composition of alcohol is higher in the two outer dopes than the inner dope.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

In followings, the effects of examples of the present invention will be described. Note that the present invention is not restricted in the examples.

### EXAMPLE 1

At first, in the film production line 10, the chrome coating was made on the surface of the casting drum 32. On the surface of the cylindrical drum 32 whose diameter was 1000 mm the dope 21 was cast to form the casting film 33, such that the thickness after the drying might be 80 μm. When the casting film 33 had a self supporting property, the casting film 33 was peeled as the wet film 38 with use of the roller 36. In the transfer area 13 and the pin tenter 14, the wet film 38 was dried to be the film 20, in which the content of the remaining solvent was decreased to a predetermined value. Thereafter the film 20 was sent to the drying chamber 15, and dried such that the content of remaining solvent might be to the predetermined value. Then the film 20 was cooled to the predetermined temperature, and then wound around the winding shaft 51 disposed in the winding chamber 17.

In the film production, the cleaning gas was continuously blown to the surface of the casting drum 32 from the peeling of the casting film 33 to the casting of the dope. The drum cleaning unit 141 was Snocle (trade mark, produced by Link Star Japan Co., Ltd.), and the nozzle 65 was a nozzle with orifice of Tefron (trade mark). The cleaning gas contained the air and the dry ice particles whose averaged diameter was 15 μm. The surface temperature of the casting drum 32 was −10° C. The distance L1 from the outlet 65a of the nozzle 65 to the surface of the casting drum 32 was 15 mm, and the blowing pressure was 896 kPa. The angle 91 of a blowing direction to the casting drum 32 in a downstream side was 90°.

The sampling was made from the product film 20, and the inspection was made by the haze meter whether there is optical unevenness. As a result, the optical unevenness was not observed on the film surface. Further, the inspection was made by the optical microscope after the blowing of the cleaning gas, whether there were scratches on the surface of the casting drum 32. However, neither organic materials nor scratches were observed.

### EXAMPLE 2

The cleaning gas was blown intermittently, and other conditions were the same as Example 1. As a result, the optical unevenness was not observed on the film surface. Further, the inspection of the scratches and the organic materials on the casting drum 32 was made in the same manner of the Example 1. However neither organic materials nor scratches were observed.

### EXAMPLE 3

The UV lamp 500 was used as the drum cleaning unit 242 to emit the UV ray to the casting drum 32 continuously, and other conditions were the same as Example 1. The UV lamp was SLC-500ATK (low pressure mercury lamp, produced by GS Yuasa Lighting Ltd.). Further, the distance L2 from the UV lamp to the casting drum 32 was 20 mm. As a result, the optical unevenness was not observed on the film surface. Further, the inspection of the scratches and the organic materials on the casting drum 32 was made in the same manner of the Example 1. However neither organic materials nor scratches were observed.

### EXAMPLE 4

The UV ray was emitted intermittently, and other conditions were the same as Example 3. As a result, the optical unevenness was not observed on the film surface. Further, the inspection of the scratches and the organic materials on the casting drum 32 was made in the same manner of the Example 1. However neither organic materials nor scratches were observed.

### EXAMPLE 5

The plasma generating device 405 was used as the drum cleaning unit 142 to discharge the oxygen plasma to the casting drum 32 continuously, and other conditions were the same as Example 1. The plasma generating device was Aiplasma (trademark, produced by Matsushita Electric Works, Ltd.). Further, the distance L3 from the outlet of the oxidation plasma to the casting drum 32 was 7 mm. As a result, the optical unevenness was not observed on the film surface. Further, the inspection of the scratches and the organic materials on the casting drum 32 was made in the same manner of the Example 1. However neither organic materials nor scratches were observed.

### EXAMPLE 6

The oxygen radical was discharged intermittently, and other conditions were the same as Example 5. As a result, the optical unevenness was not observed on the film surface. Further, the inspection of the scratches and the organic materials on the casting drum 32 was made in the same manner of the Example 1. However neither organic materials nor scratches were observed.

### EXAMPLE 7

The laser source, CL500Q (produced by SAMAC Co., Ltd.) was used as the drum cleaning unit to discharge the laser beam to the casting drum 32 continuously, and other conditions were the same as Example 1. As a result, the optical unevenness was not observed on the film surface. Further, the inspection of the scratches and the organic materials on the casting drum 32 was made in the same manner of the Example 1. However neither organic materials nor scratches were observed.

### EXAMPLE 8

The laser source, CL500Q (produced by SAMAC Co., Ltd.) was used as the drum cleaning unit to discharge the laser beam to the casting drum 32 intermittently, and other conditions were the same as Example 7. As a result, the optical unevenness was not observed on the film surface. Further, the inspection of the scratches and the organic materials on the casting drum 32 was made in the same manner of the Example 1. However neither organic materials nor scratches were observed.

[Comparison 1]

The non-contact type of the drum cleaning unit was used, and other conditions were the same as Example 1. After one hour from the start of the film production, the cleaning of the casting drum 32 was made with use of the non-woven cloth from the peeling of the casting film 33 to the casting of the dope 21. As a result, the optical unevenness was observed in the produced film 20. Further, the organic materials are adhered on the surface of the casting drum 32 early after the start of the casting.

Various changes and modifications are possible in the present invention and may be understood to be within the present invention.

What is claimed is:

1. A solution casting method, comprising steps of:
casting onto a surface of an endless support a dope containing a solvent and a polymer, so as to form a casting film;
peeling said casting film as a film from said support; drying said film; and
cleaning said surface of said support after the peeling of said casting film before the next casting of said dope, so as to remove an organic material adhered to said surface.

2. A solution casting method according to claim 1, wherein the cleaning is made by blowing continuously or intermittently a cleaning gas against said surface of said support with use of a blowing device, while said cleaning gas contains particles of dry ice and a carrier gas for carrying said dry ice particles.

3. A solution casting method according to claim 2, further comprising steps of:
generating said cleaning gas by mixing in a mixture section of said blowing device said dry ice particles to a carrier gas for carrying said dry ice particles to said support, said mixture section connecting a first feeding section for feeding said dry ice particles to a second feeding section for feeding said carrier gas;
measuring by a first flow volume meter a flow volume of said dry ice particles fed to said mixing section, said first flow volume meter being disposed on a first pipe connecting said first feeding section to said mixing section;
measuring by a second flow volume meter a flow volume of said carrier gas fed to said mixing section, said second flow volume meter being disposed on a second pipe connecting said second feeding section to said mixing section; and
performing a feed back control of each of said flow volumes of said dry ice particles and said carrier gas, on the basis of measurements by said first flow volume meter and said second flow volume meter.

4. A solution casting method according to claim 2, further comprising steps of:
generating said cleaning gas by mixing in a mixture section of said blowing device a liquid carbon dioxide to a carrier gas, said liquid carbon dioxide being to form said dry ice particles, said carrier gas carrying said dry ice particles to said support, said mixture section connecting a first feeding section for feeding said liquid carbon dioxide to a second feeding section for feeding said carrier gas;
measuring by a first flow volume meter a flow volume of said liquid carbon dioxide fed to said mixing section, said first flow volume meter being disposed on a first pipe connecting said first feeding section to said mixing section;
measuring by a second flow volume meter a flow volume of said carrier gas fed to said mixing section, said second flow volume meter being disposed on a second pipe connecting said second feeding section to said mixing section; and
performing a feedback control of each of said flow volumes of said liquid carbon dioxide and said carrier gas, on the basis of measurements by said first flow volume meter and said second flow volume meter.

5. A solution casting method according to claim 4, further comprising steps of:
measuring a pressure in said first pipe by a pressure meter provided on said first pipe; and
performing a feedback control of said pressure, on the basis of measurement by said pressure meter.

6. A solution casting method according to claim 4, further comprising steps of:
measuring a temperature of said liquid carbon dioxide in said first pipe by a thermometer provided on said first pipe; and
performing a feedback control of said temperature, on the basis of measurement by said thermometer.

7. A solution casting method according to claim 2, further comprising steps of:
measuring a glossiness of a support surface of said support by a glossiness meter disposed in a downstream side from said blowing device in a running direction of said support;
measuring a real cleaning time which it takes to make said glossiness of said support surface to a predetermined value; and
controlling a blowing volume of said cleaning gas on the basis of measurement by said glossiness meter and said real cleaning time.

8. A solution casting method according to claim 1, wherein a UV ray is emitted continuously or intermittently toward said surface of said support in the cleaning.

9. A solution casting method according to claim 1, wherein a plasma is emitted continuously or intermittently toward said surface of said support in the cleaning.

10. A solution casting method according to claim 1, wherein a laser beam is emitted continuously or intermittently toward said surface of said support in the cleaning.

11. A solution casting method according to claim 1, wherein a temperature of said surface of said support is cooled to be in a range of −10° C. to 10° C. such that said casting film is gelatized to have a self-supporting property.

12. A solution casting method according to said claim 1,
wherein said polymer is cellulose triacetate, and
wherein said organic material contains at least one of aliphatic acids, aliphatic acid esters, and metal salts of aliphatic acids.
